(19) United States
(12) Patent Application Publication
(10) Pub. No.: US 2008/0276543 A1
(43) Pub. Date: Nov. 13, 2008

(54) Alkaline barrier polishing slurry

(76) Inventors: Terence M. Thomas, Newark, DE (US); Qianqiu Ye, Newark, DE (US)

Correspondence Address: ROHM AND HAAS ELECTRONIC MATERIALS;CMP HOLDINGS, INC., 451 BELLEVUE ROAD, NEWARK, DE, 19713, US

(21) Appl. No.: 11/801,151

(22) Filed: May 8, 2007

(51) Int. Cl. C09K 3/14

(52) U.S. Cl. 51/298

(57) ABSTRACT

The aqueous slurry is useful for chemical mechanical polishing a semiconductor substrate having a tantalum-containing barrier layer and copper interconnects. The slurry includes by weight percent, 0 to 5 oxidizing agent, 0.1 to 25 silica particles, 0.001 to 3 polyvinyl pyrrolidone, 0.02 to 5 weight percent imine barrier removal agent selected from at least one of formamidine, formamidine salts, formamidine derivatives, guanidine, guanidine derivatives, guanidine salts and a mixture thereof, 0.02 to 5 weight percent carbonate, 0.01 to 10 inhibitor for decreasing static etch of the copper interconnects, 0.001 to 10 complexing agent and balance water; and the aqueous slurry having a pH of 9 to 11.

### BACKGROUND OF THE INVENTION

As ultra-large-scale-integrated circuit (ULSI) technology migrates to smaller line widths, there are new challenges for the integration of conventional chemical mechanical polishing (CMP) processes. In addition, the introduction of low-k and ultra-low k dielectric films requires the use of a gentler CMP processes due to the films' low mechanical strength and weak adhesion to adjacent layers. For example, porous carbon doped oxide (CDO) exhibits weakened mechanical strength and reduced thermal capacity, which present significant challenges to the ensuing process steps. In particular, delamination, scratch and rate uniformity control are of particular concern. Furthermore, ever-tightening topography, uniformity and defectivity specifications have placed additional demands on polishing slurries for low k films.

The integration of various low k films into ULSIs can also require numerous extra steps and the incorporation of new technologies such as supercritical cleaning, dielectric and metal caps, conformal deposition of barriers and copper, chemical mechanical planarization with low down force and abrasive-free slurries. The selective removal of barrier, such as tantalum-nitride barriers without excessive dishing of the interconnect also requires tighter specifications with decreasing line width. Furthermore, since barrier materials typically have strong corrosion resistance, these slurries typically require strong oxidizing agents, such as hydrogen peroxide, for acceptable removal rates.

In summary, the complexities surrounding implementation of low k materials have introduced larger challenges for the barrier CMP process, which will necessitate the ability to control the complicated input variables and achieve a consistent high yield. Tuning process variables can contribute to decreasing polishing variation on the low k film. But the most desirable barrier CMP slurry will incorporate a low k dielectric-specific, surface active agent that has process tunable performance adjustability. For example, Ye et al. in U.S. Pat. No. 6,916,742, disclose a slurry that adjusts the amount of polyvinyl pyrrolidone to control tantalum nitride and carbon doped oxide (CDO) removal rates. Adjusting the amounts of polyvinyl pyrrolidone and silica controls the ratio of tantalum nitride (barrier) to CDO (ultra low k dielectric) removal rates achieved with the slurry. Unfortunately, these slurries produce too high of defect levels for some applications.

There is a demand for a polishing slurry that can achieve the modular removal of barriers to copper with decreased defectivity. Furthermore, there is a demand for a slurry that can remove a barrier with controlled dielectric erosion and controlled copper dishing for decreasing line widths. In addition, the polishing slurry advantageously is oxidizer-free to eliminate the costs associated with providing and disposing of an oxidizer.

### DESCRIPTION OF THE DRAWING

FIG. 1 plots CDO, TEOS and copper removal rates versus pH for slurries of the invention.

### STATEMENT OF THE INVENTION

The invention provides an aqueous slurry useful for chemical mechanical polishing a semiconductor substrate having a tantalum-containing barrier layer and copper interconnects comprising by weight percent, 0 to 5 oxidizing agent, 0.1 to 25 silica particles, 0.001 to 3 polyvinyl pyrrolidone, 0.02 to 5 weight percent imine barrier removal agent selected from at least one of formamidine, formamidine derivatives, formamidine salts, guanidine, guanidine derivatives, guanidine salts and a mixture thereof, 0.02 to 5 weight percent carbonate, 0.01 to 10 inhibitor for decreasing static etch of the copper interconnects, 0.001 to 10 complexing agent and balance water; and the aqueous slurry having a pH of 9 to 11.

Another aspect of the invention provides an aqueous slurry useful for chemical mechanical polishing a semiconductor substrate having a tantalum-containing barrier layer and copper interconnects comprising by weight percent, 1 to 20 silica particles, 0.002 to 2 polyvinyl pyrrolidone, 0.05 to 3 guanidine carbonate, at least a portion of the guanidine carbonate dissociating in the slurry, 0.02 to 5 inhibitor for decreasing static etch of the copper interconnects, 0.01 to 5 organic acid complexing agent and balance water; and the aqueous slurry being oxidizer-free and having a pH of 9.5 to 10.5.

Another aspect of the invention provides an aqueous slurry useful for chemical mechanical polishing a semiconductor substrate having a tantalum-containing barrier layer and copper interconnects comprising by weight percent, 2 to 20 silica particles, 0.01 to 1.5 polyvinyl pyrrolidone, 0.05 to 2 guanidine carbonate, at least a portion of the guanidine carbonate dissociating in the slurry, 0.05 to 2 inhibitor for decreasing static etch of the copper interconnects, 0.01 to 5 organic acid complexing agent and balance water; and the aqueous slurry being oxidizer-free and having a pH of 9.5 to 10.5.

### DETAILED DESCRIPTION

It has been discovered that adding imine compounds and carbonate to a polyvinyl pyrrolidone-containing slurry can decrease defectivity without an adverse impact upon the barrier, low k and ultra low k removal rates of semiconductor substrates. For purposes of this specification, semiconductor substrates include wafers having metal conductor interconnects and dielectric materials separated by insulator layers in a manner that can produce specific electrical signals. Furthermore, these slurries have the ability to effectively remove tantalum-containing barrier slurries with oxidizer-free formulations. For purposes of this specification, an oxidizer represents a constituent capable of oxidizing the interconnect metal, such as copper or a copper alloy.

The slurry contains 0.02 to 5 weight percent carbonate to facilitate buffering the slurry at a pH between 9 and 11. This specification expresses all concentrations in weight percent, unless specifically noted otherwise. Preferably, the slurry includes 0.05 to 3 weight percent carbonate; and most preferably 0.05 to 2 weight percent carbonate for buffering the slurry and decreasing pH drift.

In addition, 0.02 to 5 weight percent imine barrier removal agent selected from at least one of formamidine, formamidine derivatives, formamidine salts, guanidine, guanidine derivatives, guanidine salts and a mixture thereof. Preferably, the slurry includes 0.05 to 3 weight percent imine barrier removal agent and most preferably 0.05 to 2 weight percent imine barrier removal agent. These barrier removal agents have particular utility for tantalum-containing barriers such as tantalum and tantalum nitride barriers. Furthermore, it is advantageous to add the imine as a carbonate salt that dissociates in the slurry, such as 0.02 to 5 formamidine carbonate or guanidine carbonate. Preferably, the slurry includes 0.05 to 3 weight percent formamidine carbonate or guanidine carbonate; and most preferably 0.05 to 2 weight percent formamidine carbonate or guanidine carbonate. Guanidine carbonate represents the most effective slurry ingredient.

The slurry contains 0.001 to 3 weight percent polyvinyl pyrrolidone for removal of barrier with selective removal rates of low-k dielectric films. Preferably, the slurry contains 0.002 to 2 weight percent polyvinyl pyrrolidone. Most preferably, the slurry contains 0.01 to 1.5 weight percent polyvinyl pyrrolidone. For applications demanding barrier removal with a modest low-k removal rate, the slurry preferably contains less than 0.4 weight percent polyvinyl pyrrolidone. For applications demanding barrier removal with a reduced low-k removal rate, the slurry preferably contains at least 0.4 weight percent polyvinyl pyrrolidone. This nonionic polymer facilitates polishing low-k and ultra low k dielectric films (typically, hydrophobic) and hard mask capping layer films.

The polyvinyl pyrrolidone preferably has a weight average molecular weight of 1,000 to 1,000,000. For purposes of this specification, weight average molecular weight refers to molecular weight measured by gel permeation chromatography. The slurry more preferably has a molecular weight of 1,000 to 500,000 and most preferably a molecular weight of 2,500 to 50,000. For example, polyvinyl pyrrolidone having a molecular weight ranging from 12,000 to 15,000 has proven particularly effective.

The slurry optionally contains 0 to 5 weight percent phosphorus-containing compound for accelerating copper removal. For purposes of this specification, a “phosphorus-containing” compound is any compound containing a phosphorus atom. Preferably, the slurry contains 0 to 3 weight percent phosphorus-containing compound. Most preferably, the slurry contains 0 to 2 weight percent phosphorus-containing compound. An optional addition of at least 0.05 weight percent phosphorous compound and preferably at least 0.1 weight percent phosphorous compound accelerates copper removal rate. For example, phosphorus-containing compounds include phosphates, pyrophosphates, polyphosphates, phosphonates, phosphine oxides, phosphine sulphides, phosphorinanes, phosphonates, phosphites and phosphinates including, their acids, salts, mixed acid salts, esters, partial esters, mixed esters, and mixtures thereof, such as, phosphoric acid. In particular, the polishing slurry may include specific phosphorus-containing compounds as follows: zinc phosphate, zinc pyrophosphate, zinc polyphosphate, zinc phosphonate, ammonium phosphate, ammonium pyrophosphate, ammonium polyphosphate, ammonium phosphonate, diammonium phosphate, diammonium pyrophosphate, diammonium polyphosphate, diammonium phosphonate, potassium phosphate, dipotassium phosphate, guanidine phosphate, guanidine pyrophosphate, guanidine polyphosphate, guanidine phosphonate, iron phosphate, iron pyrophosphate, iron polyphosphate, iron phosphonate, cerium phosphate, cerium pyrophosphate, cerium polyphosphate, cerium phosphonate, ethylene-diamine phosphate, piperazine phosphate, piperazine pyrophosphate, piperazine phosphonate, melamine phosphate, dimelamine phosphate, melamine pyrophosphate, melamine polyphosphate, melamine phosphonate, melam phosphate, melam pyrophosphate, melam polyphosphate, melam phosphonate, melem phosphate, melem pyrophosphate, melem polyphosphate, melem phosphonate, dicyanodiamide phosphate, urea phosphate, including, their acids, salts, mixed acid salts, esters, partial esters, mixed esters, and mixtures thereof.

The optional phosphorus-containing compounds include ammonium phosphate and phosphoric acid. Excessive ammonium phosphate, however, can introduce excessive amounts of free ammonium into solution. And excessive free ammonium can attack the copper to produce a rough metal surface. Adding phosphoric acid reacts with free alkali metals in situ, such as potassium to form potassium phosphate salt and dipotassium phosphate salt that are particularly effective.

The potassium compound also provides the benefit of forming a protective film that protects copper in aggressive post-CMP cleaning solutions. For example, the post-CMP wafer's film has sufficient integrity to protect the wafer in alkaline solutions having aggressive copper complexing agents such as, tetramethylammonium hydroxide, ethanolamine and ascorbic acid.

The slurry optionally contains 0 to 5 weight percent oxidizing agent to further facilitate removal of barrier layers, such as tantalum, tantalum nitride, titanium and titanium nitride. Suitable oxidizers include, for example, hydrogen peroxide, monopersulfates, iodates, magnesium perphthalate, peracetic acid and other peracids, persulfates, bromates, periodates, nitrates, iron salts, cerium salts, manganese (Mn) (III), Mn (IV) and Mn (VI) salts, silver salts, copper salts, chromium salts, cobalt salts, halogens, hypochlorites, or combinations comprising at least one of the foregoing oxidizers. The preferred oxidizer is hydrogen peroxide. It is to be noted that the oxidizer is typically added to the polishing composition just prior to use and in these instances the oxidizer is contained in a separate package and mixed at the place of use. This is particularly useful for unstable oxidizers, such as, hydrogen peroxide. Preferably the slurry is oxidizer-free for improving the slurry's stability, eliminating the need for a second feed stream and decreasing cost.

Adjusting the amount of optional oxidizer, such as peroxide, can also control the metal interconnect removal rate. For example, increasing the peroxide concentration increases the copper removal rate. Excessive increases in oxidizer, however, provide an adverse impact upon polishing rate.

The barrier metal polishing composition includes a silica abrasive for “mechanical” removal of the barrier material. The abrasive is preferably a colloidal silica abrasive. The silica abrasive has a concentration in the aqueous phase of the polishing composition of 0.1 to 25 weight percent. For abrasive-free solutions, a fixed abrasive pad assists with the removal of the barrier layer. Preferably, the abrasive concentration is 1 to 20 weight percent. And most preferably, the abrasive concentration is 2 to 20 weight percent. Typically, increasing abrasive concentration increases the removal rate of dielectric materials; and it especially increases the removal rate of low-k dielectric materials, such as carbon-doped oxide. For example, if a semiconductor manufacturer desires an increased low-k dielectric removal rate, then increasing the abrasive content can increase the dielectric removal rate to the desired level.

The abrasive preferably has an average particle size of less than 250 nm for preventing excessive metal dishing and dielectric erosion. For purposes of this specification, particle size refers to the colloidal silica's average particle size. Most preferably, the silica has an average particle size of less than 150 nm to further reduce metal dishing and dielectric erosion. In particular, an average abrasive particle size less than 100 nm removes the barrier metal at an acceptable rate without excessive removal of the dielectric material. For example, the least dielectric erosion and metal dishing occur with a colloidal silica having an average particle size of 10 to 100 nm. Decreasing the size of the colloidal silica tends to improve the selectivity of the solution; but it also tends to decrease the barrier removal rate. In addition, the preferred colloidal silica may include additives, such as dispersants to improve the stability of the silica at acidic pH ranges. One such abrasive is colloidal silica that is available from AZ Electronic Materials France S.A.S., of Puteaux, France.

In addition to the inhibitor, 0.001 to 10 weight percent complexing agent prevents precipitation of nonferrous metals. Most preferably, the slurry contains 0.01 to 5 weight percent complexing agent. Preferably, the complexing agent is an organic acid. Example complexing agents include the following: acetic acid, citric acid, ethyl acetoacetate, glycolic acid, lactic acid, malic acid, oxalic acid, saliclylic acid, sodium diethyl dithiocarbamate, succinic acid, tartaric acid, thioglycolic acid, glycine, alanine, aspartic acid, ethylene diamine, trimethyl diamine, malonic acid, gluteric acid, 3-hydroxybutyric acid, propionic acid, phthalic acid, isophthalic acid, 3-hydroxy salicylic acid, 3,5-dihydroxy salicylic acid, gallic acid, gluconic acid, pyrocatechol, pyrogallol, tannic acid, and salts thereof. Preferably, the complexing agent is selected from the group consisting of acetic acid, citric acid, ethyl acetoacetate, glycolic acid, lactic acid, malic acid, oxalic acid. Most preferably, the complexing agent is citric acid.

An addition of 0.01 to 10 total weight percent inhibitor decreases removal rate of copper interconnects and protects the copper from static etch. For purposes of this application, copper interconnect refers to interconnects formed with copper having incidental impurities or copper-base alloys. Adjusting the concentration of an inhibitor adjusts the copper interconnect removal rate by protecting the metal from static etch. Preferably the slurry contains 0.02 to 5 weight percent inhibitor. Most preferably, the solution contains 0.05 to 2 weight percent inhibitor. The inhibitor may consist of a mixture of inhibitors. Azole inhibitors are particularly effective for copper interconnects. Typical azole inhibitors include benzotriazole (BTA), mercaptobenzothiazole (MBT), tolytriazole and imidazole. BTA is a particularly effective inhibitor for copper interconnects and imidazole can increase copper removal rate.

The polishing composition has a pH of 9 to 11 and a balance water. Preferably, the pH is between 9.5 and 10.5. In addition, the solution most preferably relies upon a balance of deionized water to limit incidental impurities. A source of hydroxy ions, such as ammonia, sodium hydroxide or potassium hydroxide adjusts the pH in the basic direction. Most preferably, the source of hydroxy ions is potassium hydroxide.

Optionally, the slurry may contain leveling agents such as chlorides or in particular, ammonium chloride, buffers, dispersion agents and surfactants. For example, the slurry optionally contains 0.0001 to 0.1 weight percent ammonium chloride. Ammonium chloride provides an improvement in surface appearance and it can also facilitate copper removal by increasing the copper removal rate.

The polishing composition can further optionally include defoaming agents, such as non-ionic surfactants including esters, ethylene oxides, alcohols, ethoxylate, silicon compounds, fluorine compounds, ethers, glycosides and their derivatives, and the like. The defoaming agent can also be an amphoteric surfactant. The polishing composition may optionally contain biocides, such as Kordek™ MLX (9.5-9.9% methyl-4-isothiazolin-3-one, 89.1-89.5% water and ≦1.0% related reaction product) or Kathon™ ICP III containing active ingredients of 2-methyl-4-isothiazolin-3-one and 5-chloro-2-methyl-4-isothiazolin-3-one, each manufactured by Rohm and Haas Company, (Kathon and Kordek are trademarks of Rohm and Haas Company).

Preferably, the slurry polishes a semiconductor substrate by applying the slurry to a semiconductor substrate by placing 21 kPa or less downward force on a polishing pad. The downward force represents the force of the polishing pad against the semiconductor substrate. The polishing pad may have a circular shape, a belt shape or a web configuration. This low downward force is particularly useful for planarizing the semiconductor substrate to remove a barrier material from the semiconductor substrate. Most preferably, the polishing occurs with a downward force of less than 15 kPa.

### EXAMPLES

A series of slurries (Comparative Slurries A and B and Example Slurries 1 to 9—decimals indicate different batches of the base slurry) mixed with a balance of deionized water are shown below in Table 1.

TABLE 1

| | | | | | Guanidine | | | |
|---|---|---|---|---|---|---|---|---|
| | | CA | PVP | H₃PO₄ | Carbonate | | Silica | H₂O₂ |
| Slurry | BTA (wt %) | (wt %) | (wt %) | (wt %) | (wt %) | pH | (wt %) | (wt %) |
| A | 0.02 | 0.3 | 0.4 | 0.1 | | 10.50 | 14* | 0.4 |
| B | 0.02 | 0.3 | | | 0.5 | 10 | 14** | |
| 1 | 0.02 | 0.2 | 0.1 | | 0.5 | 10 | 14** | |
| 2 | 0.02 | 0.2 | 0.1 | | 1 | 10 | 14** | |
| 3 | 0.02 | 0.2 | 0.2 | | 0.5 | 10 | 14** | |
| 4 | 0.02 | 0.2 | 0.4 | | 0.5 | 10 | 14** | |
| 5 | 0.05 | 0.2 | 0.1 | | 0.5 | 10 | 14** | |
| 6 | 0.1 | 0.2 | 0.1 | | 0.5 | 10 | 14** | |
| 7 | 0.02 | 0.2 | 0.1 | | 0.5 | 10 | 6** | |
| 8 | 0.02 | 0.2 | 0.1 | | 0.5 | 10 | 10** | |
| 9 | 0.02 | 0.2 | 0.1 | | 1 | 10 | 14** | |

CA = citric acid,
PVP = polyvinyl pyrrolidone,
NH₄Cl = 0.01 wt %,
BTA = benzotriazole,
Biocide = 0.005 wt % Kordek ™ MLX manufactured by Rohm and Haas Company (9.5–9.9% methyl-4-isothiazolin-3-one, 89.1–89.5% water and ≦1.0% related reaction product),
Silica* = 1501-50 a 50 nm silica from AZ Electronic Materials France S.A.S., of Puteaux, France and
Silica** = 1501-35 a 35 nm silica from AZ Electronic Materials France S.A.S., of Puteaux, France.

### Example 1

Polishing tests employed 200 mm sheet wafers of Coral™ carbon doped oxide (CDO) from Novellus Systems, Inc., TEOS dielectric, tantalum nitride, and electroplated copper. Topographical data arise from polishing sheet wafers with IC1010™ and embossed Politex™ polishing pads from Rohm and Haas Electronic Materials CMP Technologies.

A MIRRA™ rotary type polishing platform polished the sheet wafers. First step copper polishing used Eternal slurry EPL2360 with an IC1010™ circular grooved polyurethane polishing pad on platens 1 and 2 using a Kinik AD3CG-181060 grid diamond conditioning disk. The polishing conditions for platens 1 were platen speed 93 rpm, carrier speed 21 rpm and downforce of 4 psi (27.6 kPa) and platen 2 platen speed of 33 rpm, carrier speed 61 rpm and downforce of 3 psi (20.7 kPa). The polishing conditions for platen 3 were 1.5 psi (10.3 kPa) downforce, 93 rpm platen speed, 87 rpm carrier speed with a slurry flow rate of 200 ml/min. using Hi embossed Politex™ coagulated polyurethane polishing pads.

Removal rates were calculated from the before and after polish film thicknesses. All optically transparent films were measured using a Tencor SM300 ellipsometric measuring device configured at 170×10⁻⁶Ω for copper and 28,000×10⁻⁶Ω for tantalum nitride. Wafer topography data was collected using a Dektak Veeco V200SL stylus profilometer. All the reported removal rates are in units of Å/min.

TABLE 2

| | Guanidine | | | | | | |
|---|---|---|---|---|---|---|---|
| | Carbonate | | H₂0₂ | Avg. TEOS | Cu | TaN | CDO |
| Slurry | (wt %) | pH | (wt %) | (Å/min.) | (Å/min.) | (Å/min.) | (Å/min.) |
| A.1 | 0 | 10.5 | 0.4 | 720 | 420 | 795 | 314 |
| A.2 | 0 | 10.5 | 0.4 | 733 | 360 | | 334 |
| 1.1 | 0.5 | 10 | 0 | 720 | 470 | 870 | 370 |
| 1.2 | 0.5 | 10 | 0 | 734 | 410 | | 358 |

Table 2 illustrates that the oxidizer-free guanidine carbonate slurries have at least equivalent TaN barrier removal rates as oxidizer-containing slurries with a higher pH level.

### Example 2

Table 3 represents slurries of Table 1 polished under the conditions of Example 1 for the purpose of illustrating the effect of polyvinyl pyrrolidone on low-k dielectrics, such as carbon doped oxide.

TABLE 3

| | PVP | TaN | CDO | TEOS | Cu |
|---|---|---|---|---|---|
| Slurry | (wt %) | (Å/min.) | (Å/min.) | (Å/min.) | (Å/min.) |
| B | 0 | 1120 | 585 | 1300 | 460 |
| 1.3 | 0.1 | 1050 | 463 | 1210 | 476 |
| 3 | 0.2 | 1020 | 390 | 1200 | 410 |
| 4 | 0.4 | 990 | 348 | 1120 | 420 |

PVP = polyvinyl pyrrolidone

Table 3 illustrates that polyvinyl pyrrolidone decreases carbon doped oxide rate without a negative impact on TaN, TEOS or copper rates.

### Example 3

Table 4 represents slurries of Table 1 polished under the conditions of Example 1 for the purpose of illustrating the effect of benzotriazole on copper removal rates.

TABLE 4

| | BTA | CDO | TEOS | Cu |
|---|---|---|---|---|
| Slurry | (wt %) | (Å/min.) | (Å/min.) | (Å/min.) |
| 1.4 | 0.02 | 460 | 1200 | 476 |
| 5 | 0.05 | 480 | 1200 | 346 |
| 6 | 0.1 | 600 | 1200 | 285 |

BTA = benzotriazole

Table 4 illustrates that benzotriazole decreases copper removal rate without a negative impact on carbon doped oxide or TEOS removal rates.

### Example 4

Table 5 represents slurries of Table 1 polished under the conditions of Example 1, except for a downforce of 2 psi (13.8 kPa) for the purpose of illustrating the effect of abrasive solids concentration on polish removal rates.

TABLE 5

| | Silica | TaN | CDO | TEOS | Cu |
|---|---|---|---|---|---|
| Slurry | (wt %) | (Å/min.) | (Å/min.) | (Å/min.) | (Å/min.) |
| 1.5 | 14 | 1300 | 580 | 1200 | 520 |
| 7 | 6 | 240 | 230 | 240 | 420 |
| 8 | 10 | 460 | 395 | 585 | 440 |

Silica** = 1501-35 a 35 nm silica from AZ Electronic Materials France S.A.S., of Puteaux, France.

Table 5 illustrates that silica concentration has a significant impact on tantalum nitride, carbon doped oxide, TEOS and copper removal rates.

### Example 5

Table 6 represents slurries of Table 1 polished under the conditions of Example 1, except for a downforce of 2 psi (13.8 kPa) for the purpose of illustrating the effect of guanidine carbonate on tantalum nitride removal rates.

TABLE 6

| | Guanidine | TaN | CDO | TEOS | Cu |
|---|---|---|---|---|---|
| Slurry | (wt %) | (Å/min.) | (Å/min.) | (Å/min.) | (Å/min.) |
| A.3 | 0 | 1230 | 550 | 1100 | 690 |
| 1.5 | 0.5 | 1340 | 700 | 1300 | 700 |
| 9 | 1 | 1300 | 870 | 1320 | 870 |

Guanidine = guanidine carbonate.

Table 6 illustrates that guanidine has a significant impact on increasing tantalum nitride; and in particular that an addition of 0.5 weight percent guanidine carbonate provided the most effective increase in tantalum nitride removal rate.

Table 7 below contains defect data from an Orbot laser-scattering defectivity measurement tool and AFM surface roughness measurements after cleaning with ESC 784 supplied by ATMI.

TABLE 7

| Slurry | Basic | Scratch | P.V. (nm) | RMS (nm) | RA (nm) |
|---|---|---|---|---|---|
| EPL2360 | 523 | 154 | | | |
| A | 473 | 133 | 12 | 0.45 | 0.6 |
| 1 | 152 | 37 | 9.5 | 0.5 | 0.7 |

Basic = total number of defects; and
Scratch = filtered to detect scratches from the slurry.

The data of Table 7 illustrate that the addition of guanidine carbonate improved defectivity in comparison to slurries containing hydrogen peroxide with little or no sacrifice in surface roughness properties.

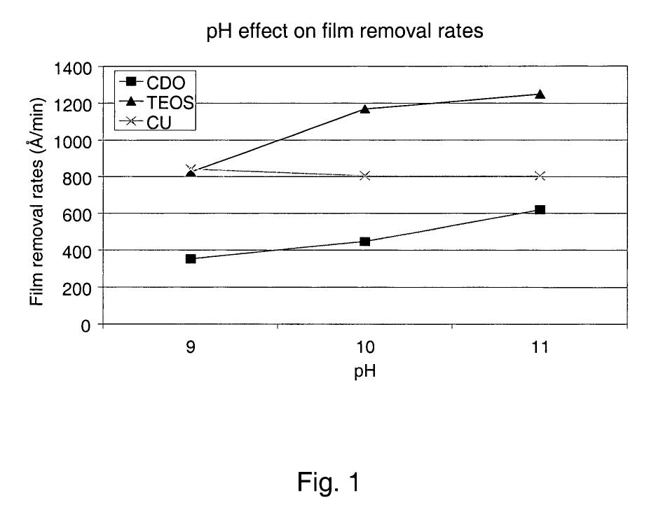

FIG. 1, illustrates that CDO, TEOS and copper removal rates all have some variation in removal rate at pH levels between 9 and 11. In addition, because guanidine carbonate buffers at a pH of 10, it also stabilizes the slurry to protect against removal rate variations arising from pH drift.

The slurry provides a decrease in defectivity with acceptable barrier, TEOS, copper and carbon-doped oxide removal rates. Furthermore, the oxidizer-free formulations provide the additional advantage of lower cost. Finally, the carbonate-containing formulation buffers the slurry to decrease pH drift and extend the product's shelf life without a detrimental variation in polishing removal rates.

1. An aqueous slurry useful for chemical mechanical polishing a semiconductor substrate having a tantalum-containing barrier layer and copper interconnects comprising by weight percent, 0 to 5 oxidizing agent, 0.1 to 25 silica particles, 0.001 to 3 polyvinyl pyrrolidone, 0.02 to 5 weight percent imine barrier removal agent selected from at least one of formamidine, formamidine derivatives, formamidine salts, guanidine, guanidine derivatives, guanidine salts and a mixture thereof, 0.02 to 5 weight percent carbonate, 0.01 to 10 inhibitor for decreasing static etch of the copper interconnects, 0.001 to 10 complexing agent and balance water; and the aqueous slurry having a pH of 9 to 11.

2. The aqueous slurry of claim 1 wherein the barrier removal agent is formamidine carbonate or guanidine carbonate.

3. The aqueous slurry of claim 2 wherein the slurry has a pH of 9.5 to 10.5.

4. An aqueous slurry useful for chemical mechanical polishing a semiconductor substrate having a tantalum-containing barrier layer and copper interconnects comprising by weight percent, 1 to 20 silica particles, 0.002 to 2 polyvinyl pyrrolidone, 0.05 to 3 guanidine carbonate, at least a portion of the guanidine carbonate dissociating in the slurry, 0.01 to 5 inhibitor for decreasing static etch of the copper interconnects, 0.01 to 5 organic acid complexing agent and balance water; and the aqueous slurry being oxidizer-free and having a pH of 9.5 to 10.5.

5. The aqueous slurry of claim 4 wherein the polyvinyl pyrrolidone has a weight average molecular weight of 1,000 to 500,000.

6. The aqueous slurry of claim 4 wherein the slurry includes silica abrasive particles having an average particle size of 10 to 100 nm.

7. The aqueous slurry of claim 4 wherein the inhibitor is an azole.

8. An aqueous slurry useful for chemical mechanical polishing a semiconductor substrate having a tantalum-containing barrier layer and copper interconnects comprising by weight percent, 2 to 20 silica particles, 0.01 to 1.5 polyvinyl pyrrolidone, 0.05 to 2 guanidine carbonate, at least a portion of the guanidine carbonate dissociating in the slurry, 0.01 to 2 inhibitor for decreasing static etch of the copper interconnects, 0.01 to 5 organic acid complexing agent and balance water; and the aqueous slurry being oxidizer-free and having a pH of 9.5 to 10.5.

9. The aqueous slurry of claim 8 wherein the complexing agent is citric acid.

10. The aqueous slurry of claim 8 wherein the silica is colloidal silica.
